(19) United States
(12) Patent Application Publication
(10) Pub. No.: US 2024/0392624 A1
(43) Pub. Date: Nov. 28, 2024

(54) T-SUPPORT PROFILE FOR GLAZING TO BE MOUNTED ON AN EXTRUSION PROFILE OF A DOOR AND/OR WINDOW FRAME

(71) Applicant: Salamander Industrie-Produkte GmbH, Tuerkheim (DE)

(72) Inventor: Till Schmiedeknecht, Muenchen (DE)

(73) Assignee: Salamander Industrie-Produkte GmbH, Tuerkheim (DE)

(21) Appl. No.: 18/259,136

(22) PCT Filed: Dec. 23, 2022
(86) PCT No.: PCT/EP2022/087794

§ 371 Date: Jun. 23, 2023

(30) Foreign Application Priority Data
Dec. 23, 2021 (DE) 10 2021 134 625.8

(51) Int. Cl. E06B 3/58

(52) U.S. Cl. CPC E06B 3/5807

(57) ABSTRACT

A T-support profile for glazing may be mounted on an extrusion profile of a door and/or window frame. The extrusion profile may have groove oriented towards the weather side of the door and/or window frame. The profile may include an abutment leg to be facing the glazing, which, in the assembled state of the T-support profile on the extrusion profile, extends parallel to the planar extension of the glazing and a wedging leg extending transversely (e.g., perpendicular) to the abutment leg and transversely (e.g., perpendicular) to the planar extension of the glazing for engaging in the groove of the extrusion profile. The area moment of inertia about the wedging leg extension direction may be least 0.25 cm⁴ and/or the area moment of inertia about the abutment leg extension direction may be least 0.02 cm⁴.

### CROSS REFERENCE TO RELATED APPLICATIONS

This patent application is a U.S. National Stage Application of International Application No. PCT/EP2022/087794, filed on Dec. 23, 2022, which claims priority to German Patent Application No. 10 2021 134 625.8, filed Dec. 23, 2021, each of which is incorporated herein by reference in its entirety.

### BACKGROUND

### Field

The present disclosure relates to a T-support profile for a glazing to be mounted on an extrusion profile of a door and/or window frame. Furthermore, the present disclosure relates to an extrusion profile for a door and/or window frame and to a door and/or window frame.

### Related Art

The extrusion profile may, for example, be made of plastic, such as polyvinyl chloride (PVC), by extrusion, in particular by co-extrusion. The extrusion profile is thus defined by an extrusion direction, which defines the longitudinal direction of the extrusion profile, in which the extrusion profile does not substantially change in cross-section. Extrusion profiles of the type are used, for example, for door and/or window frames, for example a frame profile of a pivotable sash or a linearly displaceable sliding sash, a frame profile of a stationary so-called fixed sash, a profile frame of door and/or window frames in building wall mounts, such as a case profile. Such extrusion profiles usually comprise several hollow chambers delimited by profile walls. Generally, the extrusion profile is largely hollow, comprises, in particular for delimiting and dividing the interior, usually thin-walled profile webs, which delimit the hollow chambers and/or connect the profile wall forming the outside of the extrusion profile.

Such a plastic extrusion profile is known, for example, from DE 10 2012 107 560 A1, in which the plastic profile frame has glazing accommodated on the end face, to which a so-called glass cover is assigned, which is accommodated in a groove of the plastic profile frame of the sash. The glass cover serves to hold the glazing in the plastic profile frame and acts as reinforcement against wind suction forces, with regard to a fall protection and against thermal expansion of the glazing. In DE 10 2012 107 560 A1, however, the glass cover is only formed as an optical cover-profile, which is clipped into the groove from the outside via thin latching arms. Due to the thin wall thickness, in particular of the latching arms, these are not able to reliably withstand the large forces, which are in particular acting on large-area glazing's.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIGS. 1-4: various embodiments of a door and/or window frame according to the disclosure with an extrusion profile and a T-support profile, generated along line A-A of the schematic principle sketch of a door and/or window frame according to the disclosure in FIG. 7;

FIG. 5: a perspective view of an exemplary embodiment of a T-support profile according to the disclosure;

FIG. 6: a side view of the T-support profile of FIG. 5; and

FIG. 7: a schematic principle sketch of an exemplary embodiment of a door and/or window frame according to the disclosure.

The exemplary embodiments of the present disclosure will be described with reference to the accompanying drawings. Elements, features and components that are identical, functionally identical and have the same effect are—insofar as is not stated otherwise-respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, and components have not been described in detail to avoid unnecessarily obscuring embodiments of the disclosure.

One object of the present disclosure is to overcome the disadvantages of the prior art, in particular to provide a T-support profile with improved force transmission capability and/or a more stable extrusion profile.

In accordance with one aspect of the present disclosure, a T-support profile is provided for a glazing to be mounted to an extrusion profile of a door and/or window frame, such as a door and/or window sash frame or a case frame. The door or window case is generally the fixed part of the door or window in which the movable part of the door, the sash, or the window is located. The door or window case is generally formed as a frame fixed to the foundation, which in the present disclosure is referred to as a case frame. The door or window sash generally includes a glazing and a frame enclosing the glazing, which in the present disclosure is referred to as a door and/or window sash frame. The extrusion profile may be a mono-extrusion profile or a co-extrusion profile. In the context of the present disclosure, the terms “extrusion profile”, “mono-extrusion profile” or “co-extrusion profile” are to be understood as meaning that the corresponding profile is produced by extrusion, mono-extrusion or co-extrusion. The extrusion profile may, for example, at least sectionally form a door and/or window part, such as, for example, a spar, such as a vertical spar or a horizontal spar, of either a fixed door and/or window frame part or a movable, in particular displaceable and/or pivotable, door and/or window sash frame part. For simplicity, these design options are described in the context of the present disclosure by the expression “door and/or window frame”. The extrusion profile has a groove oriented towards the weather side of the door and/or window frame, which groove is provided for at least partially receiving and attaching the T-support profile. The extrusion profile is based on an extrusion semi-finished product produced by extrusion, which has a substantially identical cross-section and a substantially identical outer dimension along the extrusion direction. For example, the extrusion profile is made of plastic, such as PVC.

The T-support profile according to the disclosure substantially has a T-shape and/or is substantially formed from two profile legs which are in particular perpendicular to one another. One of the two legs, in particular the leg forming the roof of the T-profile, takes over the abutment and support function, while the other leg, in particular the leg of the T-profile forming the trunk, takes over the attachment to the extrusion profile.

The T-support profile according to the disclosure comprises an abutment leg which is to be at least partially facing towards the glazing and which can have a section, which is to be facing towards the extrusion profile, wherein in the assembled state of the T-support profile on the extrusion profile the abutment leg extends parallel to the planar extension of the glazing.

Furthermore, the T-support profile comprises a wedging leg extending transversely, in particular perpendicular, to the abutment leg and transversely, in particular perpendicular, to the planar extension of the glazing for engaging in the groove of the extrusion profile.

The surface of the abutment leg facing away from the wedging leg can be formed planar, in particular free of protrusions and/or recesses. Structures for defined abutment with the glazing and/or the extrusion profile can be provided on the surface of the abutment leg on the wedging leg side.

A key property of the T-support profile according to the disclosure is its pronounced ability to transmit and absorb forces. In other words, the T-support profile is characterized by high rigidity or resistance against deformation. According to the disclosure, these properties are achieved by a suitable choice of material or materials and/or by the pronounced wall thickness of the abutment—and the wedging leg. For example, the abutment leg and the wedging leg have substantially the same wall thickness in the region of their transition to one another, wherein in particular a manufacturing tolerance of +2 mm, in particular of +1 mm, +0.5 mm or of +0.2 mm can be considered. Thus, that region of the T-support profile, which is subjected to the greatest load in the event of a force applied on the T-profile as a result of a thermally induced dimensional change of the extrusion profile and/or as a result of external loads acting on the glazing, is designed to be significantly more stable and thus more resistant and stiffer than is the case, for example, with the thin clip arms in DE 10 2012 107 560 A1.

According to the first aspect of the present disclosure, the area moment of inertia about the wedging leg extension direction is at least 0.25 cm⁴ and/or the area moment of inertia about the abutment leg extension direction is at least 0.02 cm⁴. According to an exemplary further development, the area moment of inertia about the wedging leg extension direction is at least 0.3 cm⁴, in particular at least 0.35 cm⁴, 0.4 cm⁴, 0.45 cm⁴, 0.5 cm⁴, 0.55 cm⁴, 0.6 cm⁴ or at least 0.65 cm⁴. Further, the area moment of inertia about the abutment leg extension direction may be at least 0.03 cm⁴, especially at least 0.04 cm⁴, 0.05 cm⁴, 0.06 cm⁴, 0.07 cm⁴, or at least 0.08 cm⁴.

Tests have shown that the T-support profile according to the disclosure can achieve a significant improvement in preventing a thermally induced dimensional change in the extrusion profile compared with the clipped-in cover-profile described in DE 10 2012 107 560 A1. The tests show that maximum thermal dimensional changes on the extrusion profile are reduced by at least a quarter, in particular by at least a third, when the T-support profile according to the disclosure is used in contrast to the clipped-in cover-profile according to DE 10 2012 107 560 A1.

According to an exemplary embodiment of the T-support profile according to the disclosure, a wall thickness of the wedging leg increases at least sectionally towards a wedging lug facing away from the abutment leg. The increase in wall thickness towards the end of the wedging leg, at which the wedging lug is arranged for abutting and wedging with a groove flank of the attachment groove of the extrusion profile, further improves the force transmission capability of the T-support profile, since the stability or strength against deformation or even material failure is increased due to the thick wall of that section of the wedging leg at which the force transmission between extrusion profile and T-support profile takes place directly.

According to a further exemplary embodiment of the T-support profile, the wedging leg comprises a latching lug opposite the wedging lug or facing the abutment leg, which latching lug projects from the wedging leg transversely to the wedging leg extension direction and is arranged to engage behind a, in particular shape-corresponding, projection of one of the groove flanks in the extrusion profile, in order to attach the T-support profile on the extrusion profile fixed in position. The latching lug can also take over a dual function, since when the T-support profile is wedged within the groove of the extrusion profile, for example as a result of a thermal dimensional change of the extrusion profile and/or when a load is applied from outside, it comes into distributive contact with a groove flank opposite the groove flank associated with the wedging lug, so that an uninterrupted force flow can take place between the groove flanks via the wedging leg with wedging lug and latching lug.

In another exemplary embodiment of the present disclosure, the abutment leg has at least one abutment projection projecting from its substantially planar surface for abutment against the extrusion profile. For example, the wedging leg divides, particularly substantially centrally, the abutment leg into two sections, a glazing abutment section of which is arranged substantially for abutment against the glazing and an extrusion profile abutment section is arranged for abutment against the extrusion profile, wherein the abutment projection is provided on the extrusion profile abutment section. The defined abutment projection has the advantage that it can be calibrated with dimensional accuracy, so that a production-precise assembly with defined alignment of the T-support profile in relation to the extrusion profile can be achieved.

According to another exemplary embodiment of the T-support profile, the abutment leg has a latching projection at an end facing away from the glazing, which is arranged to engage behind a web of the extrusion profile or as a stop for a faceplate in the abutment region of two adjacent movable windows or doors, in particular in the case of two-part windows or doors. For example, the latching projection is arranged on the extrusion profile abutment section. The latching projection may be dimensioned to project beyond the abutment projection. By cooperating with the latching projection, the faceplate can be mounted in a positionally secure manner in a simple manner, wherein in particular a relative movement between the faceplate and the extrusion profile can be delimited, in particular prevented, in the extension direction of the abutment leg.

According to another exemplary embodiment of the present disclosure, the wedging leg, in particular the wedging lug, has a surface structuring, in particular with a dimension of greater than 0 mm to 1 mm, which is arranged to produce a form—and/or force-fitting connection with the extrusion profile when wedging with the extrusion profile, in particular with the groove flanks of the attachment groove. Alternatively, or additionally, the wedging leg can be materially connected to the extrusion profile, in particular to at least one of the groove flanks. Alternatively, or additionally, the wedging leg can be attached to the extrusion profile by means of riveting, gluing, punching, knurling, drilling or via a perforation, for example a toothing, scoring, microstructuring or embedding of tapes. The surface structuring on the wedging leg can cooperate, for example, with a shape-corresponding surface structuring of the extrusion profile, in particular at least one of the groove flanks. An advantage of the surface structuring is that a fixation of the T-support profile to the extrusion profile, in particular its groove, can be achieved without the need for additional attachment means or measures. In order to strengthen the attachment and/or holding force of the T-support profile within the groove, at least one of the above-described substantive attachment measures can be applied, for example when increased strength or stiffness requirements and/or higher load effects are anticipated. According to an exemplary further development, the surface structuring is formed and arranged in such a way that it first introduces, in particular impresses, the surface structuring into the extrusion profile during wedging in order to achieve the form—and/or force-fitting connection.

According to an exemplary further development of the T-support profile according to the disclosure, the T-support profile is made of a material, in particular metal or plastic, such as a fiber-reinforced plastic (e.g., Glass Reinforced Plastic (GRP) which has a higher hardness and/or strength than the material, in particular the plastic, such as PVC, of the extrusion profile. Furthermore, according to this aspect, the surface structuring of the wedging leg is arranged to interlock or hook into the material of the extrusion profile when wedging with the extrusion profile. The surface structuring of the wedging leg and/or of the extrusion profile can be formed as a repeating mountain-valley-structure, which, in particular is formed uniformly. By selecting the material of the T-support profile according to the disclosure as a material with a higher hardness and/or strength than the material of the extrusion profile, the form—and/or force-fitting connection between the T-support profile and the extrusion profile is produced in a particularly simple manner. Due to the increased hardness and/or strength of the material of the T-support profile relative to the material of the extrusion profile, the wedging of the wedging leg with the groove flanks of the extrusion profile, as a result of a thermally induced dimensional change of the extrusion profile and/or by external load application, can be used for this purpose, to form the form—and/or force-fit, in that the harder and/or stronger material of the wedging leg deforms, displaces and/or interlocks and/or hooks in the less strong and/or less hard material of the extrusion profile.

According to another exemplary embodiment, the T-support profile may be made of metal or fiber-reinforced plastic, such as GRP, by pultrusion, for example. The pultrusion process is a particularly acclimatized process for the production of fiber-reinforced plastic profiles, in particular GRP profiles, which are produced in a continuous manufacturing process by selective bonding of fiber reinforcements and resin systems. The pultrusion process offers a high degree of design freedom and, above all, enables the production of profiles with desired properties, so that the desired mechanical properties of the T-support profile can be achieved reliably and flexibly. When using a fiber-reinforced plastic, weight can be saved compared to a support profile made of metal. The use of GRP also has the advantage of having high thermal insulation values, so that the thermal insulation on the extrusion profile is improved.

According to an exemplary further development of the T-support profile according to the disclosure, the wedging leg has a latching element, such as a latching lug or a latching recess, which is arranged on a section adjacent to the abutment leg and/or in such a way that it is urged away from a groove flank delimiting the groove, when a load is applied to the T-support profile against the wedging leg extension direction. A projection can be present on the corresponding groove flank, which the latching element engages behind in the assembly state to prevent unintentional distancing of the T-support profile from the groove. The latching element can be arranged very close to the transition or connection area between the abutment leg and the wedging leg, in particular at an end of the wedging leg facing away from the wedging lug. A major advantage of the T-support profile according to the disclosure is the structural separation of latching and lever force transmission when a load is applied to the T-support profile against the wedging leg extension direction. The fact that the latching element is urged away from the groove flank cooperating in the latching process in the event of a load, prevents the latching element from pressing against this corresponding groove flank and the lever force transmission from taking place primarily via the wedging lug, which in turn has no influence on the latching process.

According to another aspect of the present disclosure, which is combinable with the preceding aspects and exemplary embodiments, there is provided an extrusion profile for a door and/or window frame. The extrusion profile may be a mono extrusion profile or a co-extrusion profile. In the context of the present disclosure, the terms “extrusion profile”, “mono-extrusion profile” or “co-extrusion profile” are to be understood as meaning that the corresponding profile is produced by extrusion, mono-extrusion or co-extrusion. The extrusion profile may, for example, at least sectionally form a door and/or window part, such as, for example, a spar, such as a vertical spar or a horizontal spar, of either a fixed door and/or window frame part or a movable, in particular displaceable and/or pivotable, door and/or window sash frame part. For simplicity, these design options are described in the context of the present disclosure by the expression “door and/or window frame”. The extrusion profile is based on an extrusion semi-finished product produced by extrusion, which has a substantially identical cross-section and a substantially identical outer dimension along the extrusion direction. For example, the extrusion profile is made of plastic, such as PVC.

The extrusion profile according to the disclosure comprises a glazing groove for receiving a glazing. The glazing groove can be formed or delimited by a profile web of the extrusion profile manufactured from one piece, or by two separately manufactured extrusion profile webs.

The extrusion profile according to the disclosure further comprises a groove, in particular an attachment groove, oriented towards the weather side of the door and/or window frame with two opposing groove flanks. The groove further comprises a groove base opposite a groove opening, which connects the two groove flanks to one another.

Furthermore, the extrusion profile comprises a T-support profile formed in particular according to one of the aspects or exemplary embodiments described above for preventing a thermally induced dimensional change of the extrusion profile and for supporting the glazing transversely to its planar extension. The T-support profile comprises an abutment leg to be facing the glazing and a wedging leg engaging in the groove. For example, the T-support profile is attached in the groove of the extrusion profile.

According to the further aspect of the present disclosure, the wedging leg is dimensioned such that it wedges against both groove flanks in the event of a force introduced into the T-support profile as a result of a thermal dimensional change of the extrusion profile and/or a load acting on the glazing. According to an exemplary further development, the wedging leg is fixed within the groove.

In addition, the wedging leg can be materially connected to the extrusion profile, in particular to at least one of the groove flanks. Alternatively, or additionally, the wedging leg can be fastened to the extrusion profile by means of riveting, gluing, punching, knurling, drilling or via a perforation, for example a toothing, scoring, microstructuring or embedding of tapes.

The fact that the wedging leg wedges against or between the two groove flanks ensures optimized force transmission between the extrusion profile and the T-support profile. This is achieved in that the wedging leg is dimensioned in such way and/or the wedging leg and the groove being matched to one another, in particular matched in shape, in such a way that the wedging leg generates at least one contact area or contact point with each of the two groove flanks when wedging of the wedging leg occurs within the groove.

According to an exemplary further development, on a section of the abutment leg facing the glazing, the abutment leg is provided with adhesive, in particular an adhesive strip, whereby, on the one hand, an attachment and, on the other hand, a sealing of the interface between glazing and T-support profile is provided. In particular, a reliable bond can be achieved between the glazing and the profile.

According to an exemplary further development of the extrusion profile according to the disclosure, a distance between the groove flanks defining an opening cross section of the groove and a wall thickness of the wedging leg are matched to one another, in particular matched in shape. The wedging leg can be slightly undersized in the area of the opening cross section of the groove in relation to the opening cross section. This substantially ensures that the wedging leg also wedges with the groove flanks in the region of the opening angle when the T-support profile wedges within the groove, i.e. comes into contact with both groove flanks there, so that the wedging leg is already supported by the extrusion profile in this region.

In a further exemplary embodiment of the extrusion profile according to the disclosure, the wedging leg is arranged in such a way that when the wedging leg is wedged to the groove flanks, there is a direct force flow between the groove flanks via the wedging leg. The force flow therefore does not have to take a detour via the abutment leg, but enables direct force transmission between the groove flank, wedging leg and other groove flanks. This makes the mutual support and fastening to each other via the wedging particularly effective.

According to an exemplary further development of the extrusion profile according to the disclosure, the wedging leg and at least one of the groove flanks have shape-corresponding surface structuring, in particular with a dimension of greater than 0 mm to 1 mm, by means of which the T-support profile is connected in a form—and/or force-fitting manner to the extrusion profile. The surface structuring is arranged to produce a form—and/or force-fitting connection with the extrusion profile when the extrusion profile, in particular the groove flanks of the attachment groove, is wedged to the T-support profile. In addition, the wedging leg can be materially connected to the extrusion profile, in particular at least one of the groove flanks. Alternatively, or additionally, the wedging leg can be attached to the extrusion profile by means of riveting, gluing, punching, knurling, drilling or via a perforation, for example a toothing, scoring, microstructuring or embedding of tapes. The surface structuring on the wedging leg can cooperate, for example, with a shape-corresponding surface structuring of the extrusion profile, in particular at least one of the groove flanks. An advantage of the surface structuring is that a fixation of the T-support profile to the extrusion profile, in particular its groove, can be achieved without the need for additional attachment means or measures. In order to strengthen the attachment and/or holding force of the T-support profile within the groove, at least one of the above-described substantive attachment measures can be applied, for example when increased strength or stiffness requirements and/or higher load effects are anticipated. According to an exemplary further development, the surface structuring is designed and arranged in such a way that it first introduces, in particular impresses, the surface structuring into the extrusion profile during wedging in order to achieve the form-fit and/or force-fit connection.

In a further exemplary embodiment of the extrusion profile according to the disclosure, the T-support profile may be made of a material, such as metal or plastic (e.g., a fiber-reinforced plastic, such as GRP) which has a higher strength than the material, in particular plastic, such as PVC, of the extrusion profile. Furthermore, the T-support profile has a surface structuring, in particular with a dimension of greater than 0 mm to 1 mm, which can be formed, for example, as a repeating, in particular uniform, mountain-valley-structure, and/or can be arranged to interlock or hook into the material of the extrusion profile when wedging with the extrusion profile, in particular to indent into the material of the extrusion profile, wherein a displacement and/or deformation of the material of the extrusion profile is accompanied. The surface structuring of the wedging leg and/or the extrusion profile can be formed as a repeating mountain-valley-structure, which in particular is formed uniformly. By selecting the material of the T-support profile in accordance with the disclosure as a material with a higher hardness and/or strength than the material of the extrusion profile, the form—and/or force-fitting connection between the T-support profile and the extrusion profile is produced in a particularly simple manner. Due to the increased hardness and/or strength of the material of the T-support profile relative to the material of the extrusion profile, the wedging of the wedging leg with the groove flanks of the extrusion profile, as a result of a thermally induced dimensional change of the extrusion profile and/or by external load application, can be used for this purpose, to form the form—and/or force-fit, in that the harder and/or stronger material of the wedging leg deforms, displaces and/or interlocks and/or hooks in the less strong and/or less hard material of the extrusion profile.

In a further exemplary embodiment of the extrusion profile according to the disclosure, a, in particular horizontally oriented, profile web delimiting a glazing groove, in particular supporting the glazing in the vertical direction, and/or a profile web of the extrusion profile delimiting the groove, is free from support by a stiffening insert, such as a metal insert. A further advantage of the disclosure is that, because of the use and design of the T-support profile in particular according to the disclosure, sufficiently high forces can be transmitted and a sufficiently high stability is provided, so that additional stiffening inserts, which were usually necessary in the prior art, can be dispensed with. For example, a cavity arranged below the profile web delimiting the glazing groove and/or a cavity adjoining the profile web delimiting the groove for the wedging leg are free of a stiffening insert. For example, the extrusion profile is a spar of a door and/or window leaf which is completely free of a stiffening insert arranged in a cavity in the profile cross section.

In another exemplary embodiment of the extrusion profile according to the disclosure, the groove flank has a projection which is projecting in the direction of the groove, which projection is engaged behind by a latching element, such as a latching lug or a latching recess, of the wedging leg. For example, in the event of a force is introduced into the T-support profile as a result of a thermal dimensional change of the extrusion profile and/or a load acting on the glazing, the latching element is urged away from the groove flank. A major advantage of the extrusion profile according to the disclosure is the structural separation of latching and lever force transmission when a load is applied to the T-support profile against the wedging leg extension direction. The fact that the latching element is urged away from the groove flank cooperating in the latching process in the event of a load, prevents the latching element from being pressed against this corresponding groove flank and the lever force transmission from taking place primarily via the wedging lug, which in turn has no influence on the latching process.

According to another aspect of the present disclosure, which is combinable with the preceding aspects and exemplary embodiments, there is provided a door and/or window frame having an extrusion profile formed according to one of the previously described aspects or exemplary embodiments, and a glazing mounted to the extrusion profile.

According to an exemplary embodiment of the door and/or window frame according to the disclosure, it has a closed frame structure formed from the extrusion profile. In other words, the frame structure is composed of extrusion profiles according to the disclosure in such a way that it forms a closed frame structure. According to an exemplary further development, the frame structure is formed from four extrusion profiles perpendicular to each other in pairs.

According to a further aspect of the present disclosure, which can be combined with the preceding aspects and exemplary embodiments, there is provided a method for manufacturing an extrusion profile and/or a door and/or window frame in particular according to the disclosure.

According to the method according to the disclosure, an extrusion profile with a glazing groove for receiving glazing and a groove oriented towards the weather side of the door and/or window frame with two opposing groove flanks is produced, in particular by means of extrusion.

Furthermore, a T-support profile formed in particular according to one of the aspects described above for preventing a thermally induced dimensional change of the extrusion profile and for supporting the glazing transversely to its planar extension is produced, in particular by means of extrusion, wherein the T-support profile has an abutment leg to be facing the glazing and a wedging leg engaging in the groove.

According to the method according to the disclosure, the T-support profile is mounted, in particular locked, in the groove provided for this purpose in the extrusion profile before the glazing is mounted in the glazing groove. In an exemplary further embodiment, the T-support profile can serve as a guide when the glazing is mounted in the glazing groove. In other words, the glazing can be guided along the T-support profile, in particular in a supporting manner, during mounting in the glazing groove.

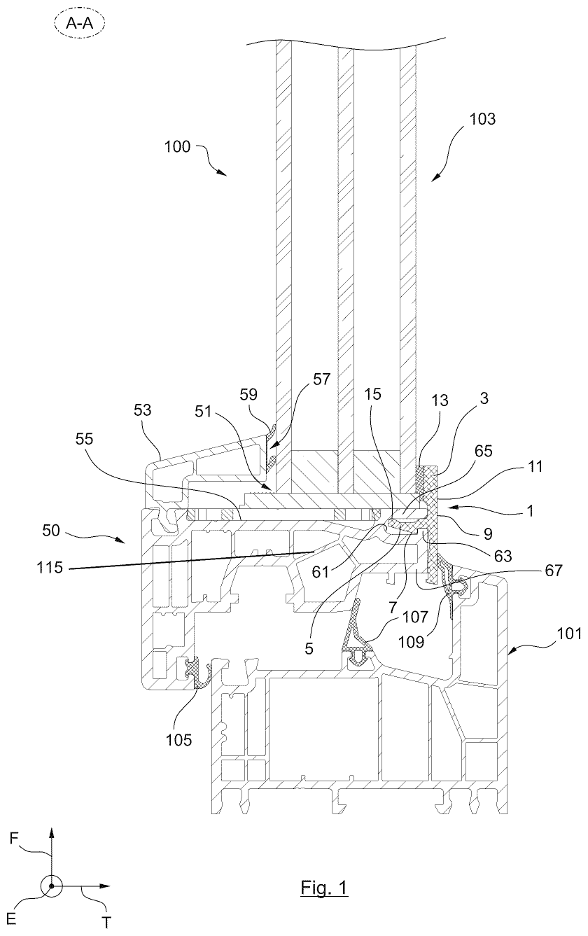

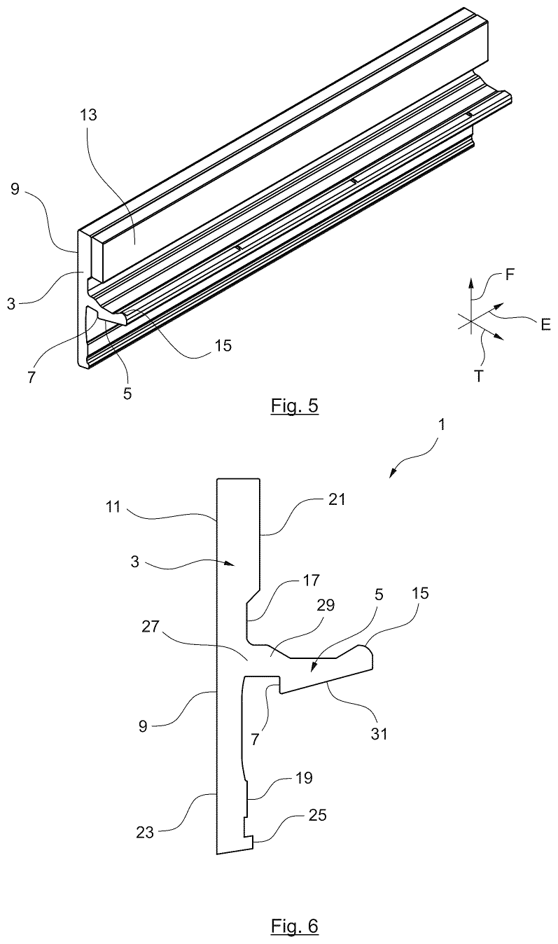

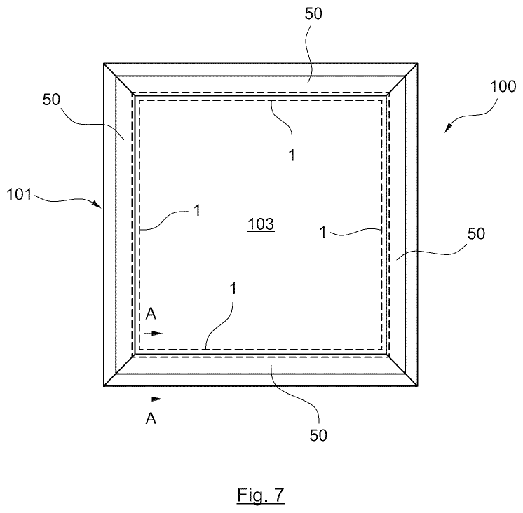

In the following description of exemplary embodiments of the present disclosure based on the accompanying figures, identical or similar components are given identical or similar reference signs. With reference to FIGS. 1 to 4, the assembly situation of a T-support profile according to the disclosure, which is generally provided with the reference sign 1, on an extrusion profile, which is generally provided with the reference sign 50, of a door and/or window frame 100 identified by the reference sign 100 is illustrated. FIGS. 5 and 6 show an exemplary embodiment of a T-support profile 1 according to the disclosure. FIG. 7 schematically shows a door and/or window frame 100 made from an extrusion profile 50 according to the disclosure, wherein the arrangement of a T-support profile according to the disclosure is schematically shown by dashed lines.

Referring to FIG. 1, a first exemplary embodiment of a door and/or window frame 100 is shown in which an extrusion profile 50 is provided having a glazing groove 51 into which a glazing 103 is inserted. According to FIG. 1, the glazing groove 51 is formed by the extrusion profile 50, which has an extruded angle profile 53, extending from a side forming a glazing groove base in the direction of the planar extension F to overlap with the glazing 103 in a depth direction T oriented perpendicularly to the planar extension direction F and to the extrusion direction E. A glazing seal 59 is provided in the overlap region 57, which is, for example, attached to the angle profile 53 by a material fit and/or by extrusion thereto, or is produced therewith in the co-extrusion process.

The extrusion profile 50 with the glazing 103 received therein is coupled to a case frame profile 101 to be fixedly arranged in a foundation, wherein a plurality of seals 105-109 may be provided.

According to the disclosure, a T-support profile 1 is used, on the one hand, to delimit, in particular prevent, a thermally induced dimensional change of the extrusion profile and, on the other hand, to support the glazing 103 transversely to its planar extension against loads acting from outside, such as wind loads. An essential property of the T-support profile 1 according to the disclosure is thus its rigidity and resistance to deformation, as well as its increased force transmission and force absorption capacity. The specific embodiment of the T-support profile is clearly described with reference to FIGS. 5-6.

In this case, a horizontally oriented profile web 55 delimiting a glazing groove 51, in particular supporting the glazing in the vertical direction, and/or a profile web delimiting the groove 61, namely one of the groove flanks 63, 65, of the extrusion profile 50 is free of support by a stiffening insert, such as a metal insert.

FIGS. 1-4 show the installation situation. It can be seen from this that an abutment leg 3 to be facing the glazing 103 and the support profile 50 and extending parallel to the planar extension F of the glazing 103 extends up to the glazing 103 and beyond the extension of the extrusion profile 50 in the extension direction F. Furthermore, the T-support profile 1 comprises a wedging leg 5 extending perpendicular to the planar extension direction F and to the abutment leg 3, which wedging leg 5 projects into and engages in a weather-sided groove 61 of the extrusion profile 50.

A latching lug 7 is provided on the wedging leg 5, which engages behind a groove flank 63 delimiting an opening cross section with a projection extending into the groove 16, in order to receive the T-support profile 1 in a positionally secure manner in the groove 61. An upper side 9 of the abutment leg facing away from the extrusion profile 50 cooperates with the seal 109, which is attached to the case frame profile 101. At a section 11 of the abutment leg 3 facing the glazing 103, the latter is provided with adhesive, in particular an adhesive strip 13, which provides, on the one hand, an attachment and, on the other hand, a sealing of the interface between the glazing 103 and the T-support profile 1. In the event of a thermally induced dimensional change of the extrusion profile 50 and/or in the event of external load application, in particular from the weather side of the door and/or window frame 100, the T-support profile 1 wedges against the extrusion profile 50. This is occurs by the contact—and support points of the abutment leg 3 on the extrusion profile 50 and, in particular, by the wedging leg 5 projecting into the groove 61, which is clamped or is wedged against the two opposing groove flanks 63, 65 of the groove 61. As can be seen in the figure, the wedging leg 5 comes into abutment—or wedging contact with a respective one of the groove flanks 63, 65, both with a front-sided wedging lug 15 and with the opposing latching lug 7.

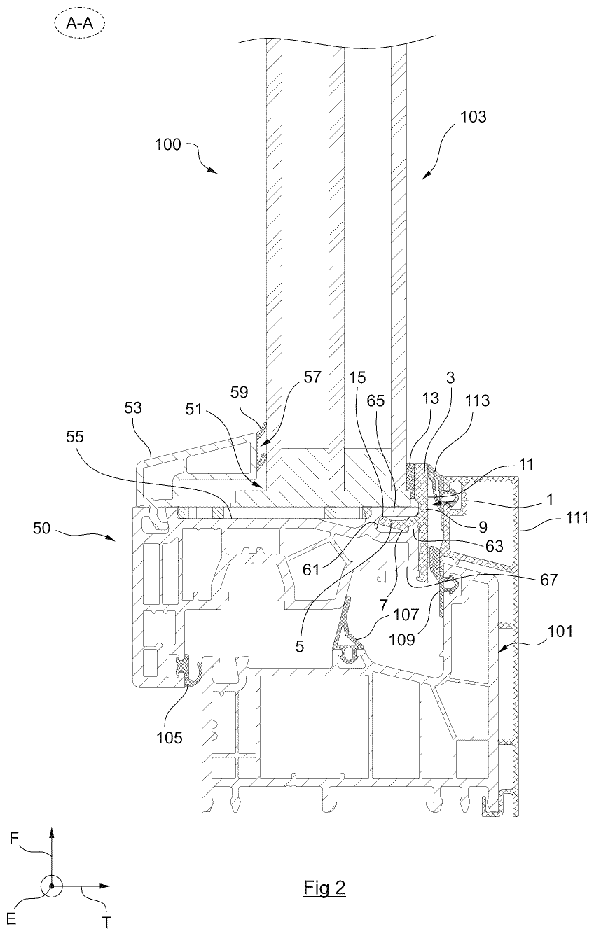

The extrusion profile 50 also has a tension web 115, which is arranged and oriented in such a way that when a force is introduced into the T-support profile (1) as a result of a thermal dimensional change of the extrusion profile (50) and/or a load acting on the glazing (103), there is an improvement in stability. According to the embodiment shown in FIGS. 1 and 2, the tension web 115 is oriented inclined with respect to the direction F and the depth direction T and connects two opposing inner profile webs of the extrusion profile 50.

In the embodiment of the door and/or window frame 100 according to FIG. 2, which substantially corresponds to the embodiment according to FIG. 1, an additional weather-sided cover 111 is fitted onto or attached to the case frame profile 101 and an additional seal 113 is provided to come into sealing contact with the T-support profile 1. Both the embodiment according to FIG. 1 and the embodiment according to FIG. 2 are a so-called triple glazing.

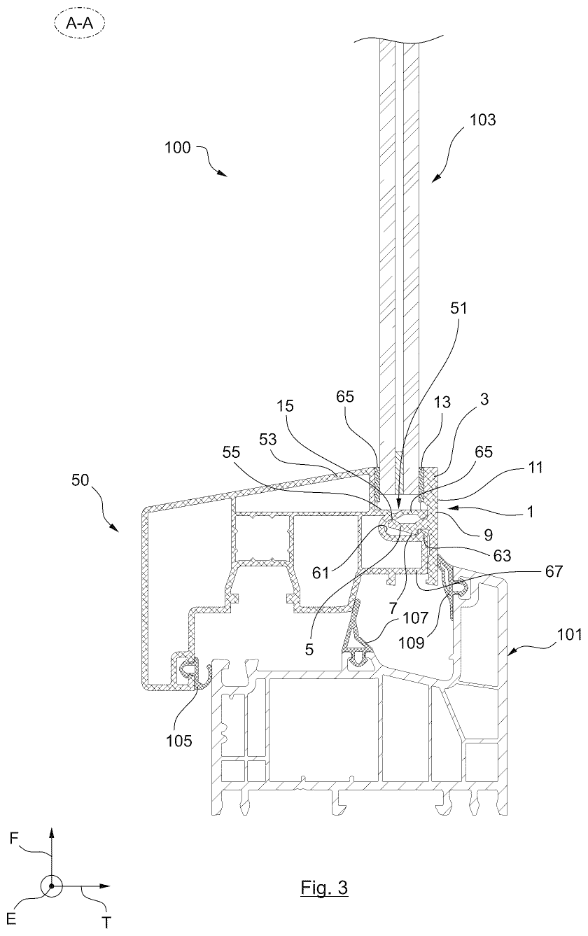

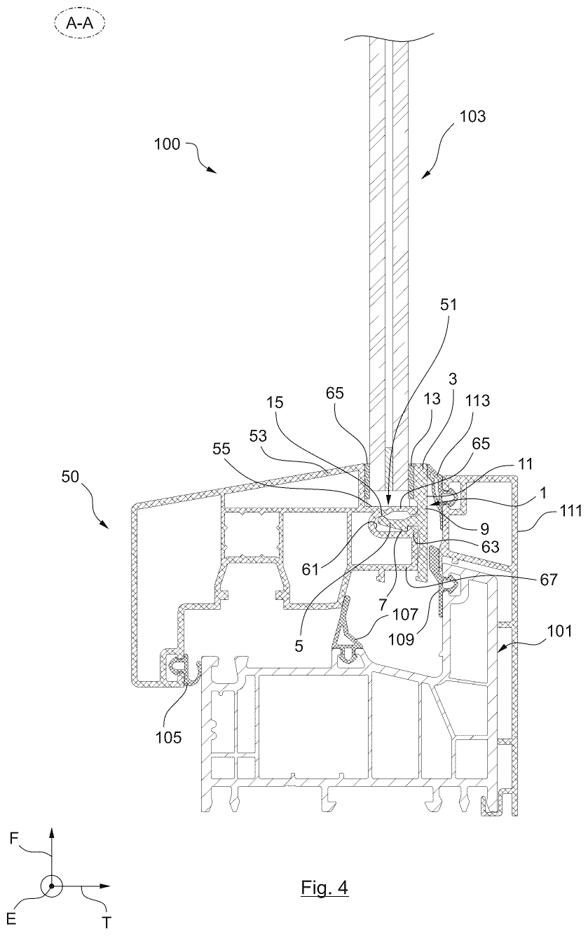

FIG. 3 shows an embodiment of a door and/or window frame 100 according to the disclosure with a double glazing 103, which illustrates that the T-support profile according to the disclosure can be used independently of the glazing. In particular, a vacuum glass 103 is used in FIG. 3. In terms of the basic principle, the embodiment according to claim 3 also corresponds to the preceding embodiments, wherein the extrusion profile 50 has a different configuration. An essential difference to the preceding embodiments is that the angle profile 53 previously delimiting the glazing groove 51 is made in one piece with the remaining extrusion profile 50. Furthermore, instead of the seal 59, an additional adhesive, indicated here as adhesive strip 65, is arranged in the region of the angle profile 53, for reinforced sealing and attachment of the glazing 103 to the extrusion profile 50. In contrast to the embodiment according to FIG. 3, the door and/or window frame 100 according to the embodiment according to FIG. 4 has, analogously to the embodiment according to FIG. 2, the outer cover profile 111, in particular made of metal, which can serve as a shell.

A synopsis of FIGS. 5 and 6 reveals an exemplary embodiment of the T-support profile 1. As can be seen in particular in FIG. 6, the abutment leg 3 comprises a substantially planar surface 9 facing away from the wedging leg 5. The surface 17 facing away from the surface 9 has defined abutment projections or—surfaces 19, 21 on the one hand for attaching the adhesive strip 13 and on the other hand for defined abutment against the extrusion profile 50. At an end opposite the abutment leg glazing section, the abutment leg 3 comprises an abutment leg extrusion profile section 23, on the side of which facing the extrusion profile, the abutment projection 19 is provided, as well as an end-sided latching projection 25, which overlaps the extrusion profile 50 in the extension direction F and can thus engage behind a web 67 of the extrusion profile 50, whereby there is the possibility of being able to mount a faceplate in the abutment region in the case of two-part windows or two-part doors in a simple manner and to hold it in a positionally secure manner in order to prevent or limit a relative movement between the faceplate and the extrusion profile 50 in the direction of extension F. At the transition 27 between the abutment leg 3 and the wedging leg 5, the T-support profile 1 has a solidly formed mouth region which, among other things, supports the tube rigidity and increased force transmission—and force absorption capacity. Adjacent to the solid transition region 27 is a substantially straightly extending section 29 of the wedging leg, from which the latching lug 7 extends substantially in the extension direction F to provide latching to secure the position of the support profile 1 within the groove 61. Starting from the latching lug tip, the wedging leg 5 extends over an inclined leg surface 31 towards the end of the wedging leg, at which the wedging lug 15, which increases in wall thickness, is formed.

From the schematic principle sketch 7 it can be seen that the door and/or window frame 100 according to the disclosure has a closed frame structure, in which two extrusion profiles 50 formed according to the disclosure are perpendicular to each other in pairs to form the frame structure. It is indicated by the dashing that also circumferentially closed the T-support profile 1 according to the disclosure is provided to fully circumferentially support the glazing 103 and the extrusion profile 50.

The features disclosed in the foregoing description, figures, and claims may be significant, both individually and in any combination, for the realization of the disclosure in the various embodiments.

### LIST OF REFERENCE SIGNS

1 T-support profile
3 Abutment leg
5 Wedging leg
7 Latching lug
9 Upper side
11 Section
13 Adhesive strip
15 Wedging lug
17 Surface
19, 21 Abutment projection
23 Abutment leg extrusion profile section
25 Latching projection
27 Transition
29 Section
31 Leg surface
50 Extrusion profile
51 Glazing groove
53 Angle profile
55 Profile web
57 Overlap region
59 Seal
61 Groove
63, 65 Groove flank
67 Web
100 Door and/or window frame
101 Frame profile
103 Glazing
105-109 Seal
111 Cover
113 Seal
115 Tension web
E Extrusion direction
F Planar extension of glazing
T Depth direction

1. A T-support profile for a glazing mountable on an extrusion profile of a door and/or window frame, the extrusion profile having a groove oriented towards a weather side of the door and/or window frame, the T-support profile comprising:
an abutment leg adapted to: face the glazing, and in an assembled state of the T-support profile on the extrusion profile, extend, parallel to a planar extension of the glazing; and
a wedging leg extending transversely to the abutment leg and transversely to the planar extension of the glazing, the wedging leg being adapted to engage in the groove of the extrusion profile.

2. The T-support profile according to claim 1, wherein a wall thickness of the wedging leg increases, at least sectionally, towards a wedging lug facing away from the abutment leg.

3. The T-support profile according to claim 1, wherein the abutment leg includes at least one abutment projection projecting from a planar surface of the abutment leg, the at least one abutment projection being adapted to abut against the extrusion profile.

4. The T-support profile according to claim 1, wherein the abutment leg comprises, at an end facing away from the glazing, a latching projection adapted to engage behind a web of the extrusion profile.

5. The T-support profile according to claim 1, wherein the wedging leg comprises a surface structuring adapted to produce a form-fitting connection and/or a force-fitting connection with the extrusion profile when wedging with the extrusion profile.

6. T-support profile according to claim 5, wherein:
the T-support profile is made of a material having a higher hardness and/or strength than a material of the extrusion profile; and
the material of the T-support profile comprises a surface structuring adapted to interlock with the material of the extrusion profile when wedging with the extrusion profile.

7. The T-support profile according to claim 1, wherein the T-support profile is made of metal or fiber-reinforced plastic.

8. The T-support profile according to claim 1, wherein the wedging leg comprises a latch arranged on a section adjacent to the abutment leg and/or adapted to be urged away from a groove flank delimiting the groove, in response to a load being applied to the T-support profile against the wedging leg extension direction.

9. An extrusion profile for a door and/or window frame, comprising:
a glazing groove adapted to receive a glazing;
a groove oriented towards a weather side of the door and/or window frame with two opposing groove flanks; and
a T-support profile adapted to prevent a thermally induced dimensional change of the extrusion profile and to support the glazing transversely to a planar extension of the glazing, the T-support profile including an abutment leg adapted to face the glazing and a wedging leg adapted to be engaged in the groove,
wherein the wedging leg is adapted to wedge against both of the groove flanks in response to a force being introduced into the T-support profile resulting from a thermal dimensional change of the extrusion profile and/or a load acting on the glazing.

10. The extrusion profile according to claim 9, wherein a distance between the groove flanks defining an opening cross section of the groove and a wall thickness of the wedging leg are matched to one another.

11. The extrusion profile according to claim 9, wherein the wedging leg is adapted, in response to the wedging being wedged to the groove flanks to provide a direct force flow between the groove flanks via the wedging leg.

12. The extrusion profile according to claim 9, wherein the wedging leg and at least one of the groove flanks have a shape-corresponding surface structuring adapted to connect the T-support profile in a form-fitting manner and/or a force-fitting manner to the extrusion profile.

13. The extrusion profile according to claim 9, wherein:
the T-support profile is made of a material having a higher hardness and/or strength than a material of the extrusion profile; and
the material of the T-support profile comprises a surface structuring adapted to interlock with the material of the extrusion profile in response to a wedging with the extrusion profile.

14. The extrusion profile according to claim 9, further comprising a profile web, delimiting the glazing groove free of support by a stiffening insert, and/or a profile web of the extrusion profile delimiting the groove is free of support by a stiffening insert.

15. The extrusion profile according to claim 9, a groove flank of the two groove flanks has a projection adapted to project in a direction of the groove, the projection being engaged behind by a latch of the wedging leg.

16. A door and/or window frame comprising:
an extrusion profile according to claim 8; and
a glazing adapted to be mounted to the extrusion profile.

17. The door and/or window frame according to claim 16, comprising a closed frame structure formed from the extrusion profile.

18. The extrusion profile according to claim 15, wherein, in response to a force being introduced into the T-support profile as a result of a thermal dimensional change of the extrusion profile and/or a load acting on the glazing, the latch is adapted to be urged away from the groove flank.

19. The T-support profile according to claim 1, wherein an area moment of inertia about a wedging leg extension direction is at least 0.25 cm⁴ and/or an area moment of inertia about an abutment leg extension direction is at least 0.02 cm⁴.
